(19) United States
(12) Patent Application Publication
(10) Pub. No.: US 2009/0278815 A1
(43) Pub. Date: Nov. 12, 2009

(54) TOUCH PANEL

(75) Inventors: Jian-Feng Li, Taichung County (TW); Gwo-Sen Lin, Taichung City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: WINTEK CORPORATION, Taichung (TW)

(21) Appl. No.: 12/436,788

(22) Filed: May 7, 2009

(30) Foreign Application Priority Data
May 8, 2008 (TW) 97116990

(51) Int. Cl. G06F 3/045

(52) U.S. Cl. 345/174

(57) ABSTRACT

A touch panel includes a first substrate, a first electrode layer, a second substrate, a second electrode layer and an extrinsic spacing layer. The first electrode layer is disposed on the first substrate, and the second substrate is parallel to the first substrate. The second electrode layer is disposed on the second substrate, and the first electrode layer and the second electrode layer are located between the first substrate and the second substrate. In addition, the extrinsic spacing layer is located between the first electrode layer and the second electrode layer, wherein a plurality of conductive particles is scattered in the extrinsic spacing layer.

### CROSS-REFERENCE TO RELATED APPLICATION

This application claims the priority benefit of Taiwan application serial no. 97116990, filed on May 8, 2008. The entirety of the above-mentioned patent application is hereby incorporated by reference herein and made a part of specification.

### BACKGROUND OF THE INVENTION

1. Field of the Invention

The present invention generally relates to a touch panel, and more particularly, to a resistive-type touch panel.

2. Description of Related Art

In recent years, along with the developments and the applications of information technology, wireless mobile communication and household information appliance products, to achieve the goals of more convenient usage, more compact design and more humanized features, many information products have changed the traditional input devices such as keyboard or mouse into touch panel, wherein the touch-type liquid crystal display apparatus is counted as the most popular one among the new style information products.

In general, the resistive-type touch panel is the most-developed one among various touch panels. FIG. 1 is a cross-sectional diagram of a conventional touch panel. Referring to FIG. 1, a touch panel 100 includes a first substrate 110, a second substrate 120, a first electrode layer 112, a second electrode layer 122 and a plurality of spacers 130. The first electrode layer 112 is disposed on the first substrate 110, the second electrode layer 122 is disposed on the second substrate 120 and the electrode layers 112 and 122 are disposed between the substrates 110 and 120. The spacers 130 are disposed between the first electrode layer 112 and the second electrode layer 122.

Generally, a gap g between the first electrode layer 112 and the second electrode layer 122. By touching with a finger or an object, the first substrate 110 is bended, and the first electrode layer 112 and the second electrode layer 122 are electrically connected. Therefore, an electrical property change (voltage drop or current change) occurs at a corresponding location of the touch panel 100 provides an input function. The disposed spacers 130 are apt to avoid inordinate signals caused by unwanted conductions between the first electrode layer 112 and the second electrode layer 122.

However, in the conventional touch panel 100, the first electrode layer 112 and the second electrode layer 122 are ceaselessly bent to or over a certain angle so as to make the two electrode layers (112 and 122) contacted by each other for producing input signals. As a result, the first electrode layer 112 and the second electrode layer 122 would be easily damaged due to cyclically bending and contacting, which further shortens the lifetime of the touch panel 100. In addition, there is no other material layer but the spacers 130 are disposed between the two electrode layers (112 and 122) in the conventional touch panel 100. Therefore, when light passes through the gap g, a part of the light is reflected or scattered, this causes a poor optical transmittance. In short, the conventional art is disadvantageous in easily damaging the electrodes (112 and 122) of the touch panel 100, shorter lifetime and poor optical transmittance.

### SUMMARY OF THE INVENTION

Accordingly, the present invention is directed to a touch panel capable of lengthening the lifetime of a resistive-type touch panel and increasing the optical transmittance of the touch panel.

The present invention provides a touch panel, which includes a first substrate, a first electrode layer, a second substrate, a second electrode layer and an extrinsic spacing layer. The first electrode layer is disposed on the first substrate, and the second substrate is parallel to the first substrate. The second electrode layer is disposed on the second substrate, and the first electrode layer and the second electrode layer are located between the first substrate and the second substrate. The extrinsic spacing layer is located between the first electrode layer and the second electrode layer, wherein a plurality of conductive particles is scattered in the extrinsic spacing layer.

In an embodiment of the present invention, the material of the above-mentioned extrinsic spacing layer is an elastic material which includes silicone gel or acrylic gel.

In an embodiment of the present invention, the material of the above-mentioned extrinsic spacing layer is a liquid material having a plurality of spacers, wherein the heights of the spacers are less than the gap between the first substrate and the second substrate. The above-mentioned liquid material is, for example, liquid crystal.

In an embodiment of the present invention, the material of the above-mentioned conductive particles includes a conductive polymer. The conductive polymer includes polyethylene dioxythiophene (PEDOT) or polyaniline (PANi).

In an embodiment of the present invention, the above-mentioned conductive particles are a plurality of nanoparticles. In an embodiment, the nanoparticle includes silver nanoparticle, carbon nanoparticle, carbon nanotube, silver nanospider, zinc oxide (ZnO) nanoparticle, indium tin oxide (ITO) nanoparticle, titanium nanoparticle or a combination of the above-mentioned nanoparticles.

In an embodiment of the present invention, the resistance of the above-mentioned extrinsic spacing layer is proportional to the thickness of the extrinsic spacing layer.

In an embodiment of the present invention, the refractive index of the above-mentioned extrinsic spacing layer is substantially greater than 1.3 but less than 2.0.

In an embodiment of the present invention, the optical transmittance of the above-mentioned extrinsic spacing layer is substantially greater than 85% but less than 100%.

In an embodiment of the present invention, the material of the above-mentioned first substrate and second substrate includes glass, acrylate, polyamide, polyethylene terephthalate (PET), polycarbonate (PC) or a combination thereof.

In an embodiment of the present invention, the material of the above-mentioned first electrode layer and second electrode layer includes indium tin oxide (ITO), cadmium tin oxide (CTO), zinc aluminium oxide (AZO), indium zinc oxide (IZO), zinc oxide (ZnO), tin oxide (SnO₂) or a combination thereof.

The present invention also provides a touch panel, which includes a first substrate, a first electrode layer, a second substrate, a second electrode layer and an extrinsic spacing layer. The first electrode layer is disposed on the first substrate, and the second substrate is parallel to the first substrate. The second electrode layer is disposed on the second substrate, and the first electrode layer and the second electrode layer are located between the first substrate and the second substrate. The extrinsic spacing layer is located between the first electrode layer and the second electrode layer and has a thickness, wherein the extrinsic spacing layer comprises an insulation elastic material and a plurality of conductive particles scattered in the insulation elastic material, so that the resistance of the extrinsic spacing layer is proportional to the thickness of the extrinsic spacing layer.

In an embodiment of the present invention, the above-mentioned touch panel further includes a signal sensor electrically connected to the first electrode layer and the second electrode layer. When the thickness is less than a threshold thickness, the resistance of the extrinsic spacing layer is reduced to enable the signal sensor detecting a voltage or a current passing the extrinsic spacing layer; when the thickness is greater than the threshold thickness, the resistance of the extrinsic spacing layer is increased and the signal sensor is unable to detect the voltage or the current passing the extrinsic spacing layer.

In an embodiment of the present invention, the above-mentioned insulation elastic material includes silicone gel or acrylic gel.

In an embodiment of the present invention, the refractive index of the above-mentioned extrinsic spacing layer is substantially greater than 1.3 but less than 2.0, and the optical transmittance of the above-mentioned extrinsic spacing layer is substantially greater than 85% but less than 100%.

The touch panel of the present invention utilizes the extrinsic spacing layer with elasticity, fluidity and conductivity as the spacing layer between the first electrode layer and the second electrode layer. Therefore, the first electrode layer and the second electrode layer can be electrically connected to each other without being largely bent or directly contacting, which is helpful to lengthen the lifetime of the touch panel. In addition, the extrinsic spacing layer is transparent, which benefits improving the optical characteristic of the touch panel.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a cross-sectional diagram of a conventional touch panel.

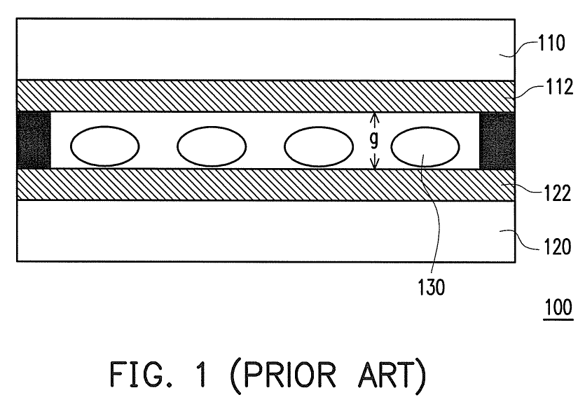

FIG. 2 is a cross-sectional diagram of a touch panel according to an embodiment of the present invention.

FIG. 3 is a diagram showing two statuses of the extrinsic spacing layer in FIG. 2 before a touching and during a touching.

FIG. 4 is a cross-sectional diagram of a touch panel according to another embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

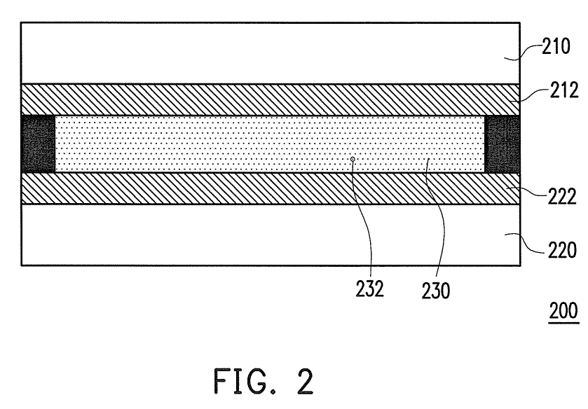

FIG. 2 is a cross-sectional diagram of a touch panel according to an embodiment of the present invention. Referring to FIG. 2, a touch panel 200 includes a first substrate 210, a first electrode layer 212, a second substrate 220, a second electrode layer 222 and an extrinsic spacing layer 230. The first electrode layer 212 is disposed on the first substrate 210 and the second substrate 220 is parallel to the first substrate 210. The second electrode layer 222 is disposed on the second substrate 220, and the first electrode layer 212 and the second electrode layer 222 are located between the first substrate 210 and the second substrate 220. The extrinsic spacing layer 230 is located between the first electrode layer 212 and the second electrode layer 222, and a plurality of conductive particles 232 are scattered in the extrinsic spacing layer 230.

The material of the first substrate 210 and the second substrate 220 includes glass, acrylate, polyamide, polyethylene terephthalate (PET), polycarbonate (PC) or a combination thereof, and the first substrate 210 or the second substrate 220 made of the above-mentioned material is, for example, flexible, so that when a user touches the touch panel, the first substrate 210 and the second substrate 220 would be slightly bent. In fact, only one of the first substrate 210 and the second substrate 220 which the user directly touches is made of the flexible material, but the other one is not limited to be made of a flexible material. In addition, the material of the extrinsic spacing layer 230 is an elastic material, which is, for example, silicone gel, acrylic gel or other nonconductive gels. Since the extrinsic spacing layer 230 is an independent block body, the extrinsic spacing layer 230 is able to adhere to the first substrate 210 and the second substrate 220 in a vacuum environment. When the touch panel 200 is touched by a user and gets pressed, a dent occurs at the touching position of the elastic extrinsic spacing layer 230; after the pressure is removed, the extrinsic spacing layer 230 restores its original status.

The touch panel 200 is a resistive-type touch panel. When a user touches the touch panel 200, the first electrode layer 212 and the second electrode layer 222 is conductive at the touching position and a corresponding signal is produced. In the present embodiment, conductive particles 232 are scattered in the extrinsic spacing layer 230, and the resistance of the extrinsic spacing layer 230 is proportional to the thickness of the extrinsic spacing layer 230. When a dent occurs in the extrinsic spacing layer 230, the thickness of the extrinsic spacing layer 230 at the position corresponding to the dent gets thinner with a lower resistance. In this way, the first electrode layer 212 is electrically connected to the second electrode layer 222 through the extrinsic spacing layer 230 at the dent position. Therefore, the first electrode layer 212 and the second electrode layer 222 are conductive there between without directly contacting, and the first electrode layer 212 and the second electrode layer 222 are unlikely damaged due to a minor bending. In short, the lifetime of the touch panel 200 can be lengthened due to disposing the extrinsic spacing layer 230.

An electrical insulation status is presented between the first electrode layer 212 and the second electrode layer 222 before the touch panel 200 is being touched, and an electrical conductive status is presented between the first electrode layer 212 and the second electrode layer 222 during the touch panel 200 is being touched. In this regard, the extrinsic spacing layer 230 has a specific electrical characteristic. In the embodiment, the material of the extrinsic spacing layer 230 preferably is a dielectric material doped by conductive particles 232, wherein the conductive particles 232 are scattered in the extrinsic spacing layer 230 for adjusting the resistance coefficient of the extrinsic spacing layer 230. The higher the content of the conductive particles 232 is, the lower the resistance coefficient of the extrinsic spacing layer 230 is, which indicates a higher conductivity. By adjusting the concentration of the conductive particles 232, the extrinsic spacing layer 230 has different electrical characteristics to meet the needs in different statuses.

In more detail, the material of the conductive particles 232 includes a kind of conductive polymer, and the conductive polymer is polyethylene dioxythiophene (PEDOT) or polyaniline (PANI). The conductive particles 232 are, for example, a plurality of nanoparticles. In the present embodiment, the nanoparticle includes silver nanoparticle, carbon nanoparticle, carbon nanotube, silver nanospider, zinc oxide (ZnO) nanoparticle, indium tin oxide (ITO) nanoparticle, titanium nanoparticle or a combination of the above-mentioned nanoparticles. In addition, the present invention dose not limit the status of the conductive particles 232, that is, the conductive particles 232 can be in many statuses, such as solid, liquid, sol or gelatine.

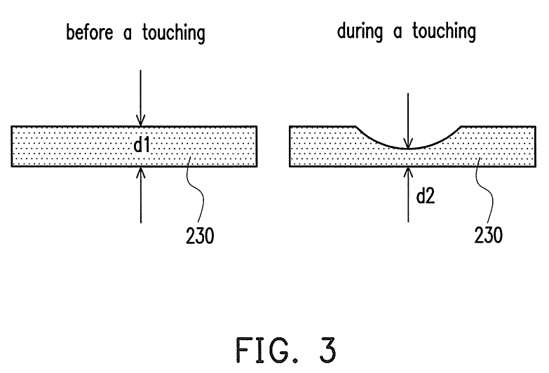

In general, the resistance of the extrinsic spacing layer 230 is subject to R=ρ×d/A, wherein R represents resistance, ρ represents resistance coefficient, d represents thickness and A represents area. FIG. 3 is a diagram showing two statuses of the extrinsic spacing layer in FIG. 2 before a touching and during a touching. Referring to FIGS. 2 and 3, the extrinsic spacing layer 230 without being touched has, for example, a thickness d1, and the resistance of the extrinsic spacing layer 230 between the first electrode layer 212 and the second electrode layer 222 is R1=ρ×d1/A. Once the touch panel 200 is touched by a user, a dent occurs in the extrinsic spacing layer 230, and the thickness of the extrinsic spacing layer 230 is, for example, d2; then resistance of the extrinsic spacing layer 230 between the first electrode layer 212 and the second electrode layer 222 is R2=ρ×d2/A. Assuming the maximal resistance between the first electrode layer 212 and the second electrode layer 222 corresponding to the conductive status is R0, then in the present embodiment, R1>R0≧R2, which indicates the quantity of the conductive particles 232 in the extrinsic spacing layer 230 substantially makes the resistance of the extrinsic spacing layer 230 corresponding to the thickness d1 greater than R0, and the resistance of the extrinsic spacing layer 230 corresponding to the thickness d2 less than R0.

In other words, when the touch panel 200 is touched, a dent occurs since the extrinsic spacing layer 230 is applied with a force, and the resistances R1 and R2 of the extrinsic spacing layer 230 is reduced with decreasing the thicknesses d1 and d2. Thus, when the extrinsic spacing layer 230 is not touched, the first electrode layer 212 and the second electrode layer 222 are insulated from each other; when the extrinsic spacing layer 230 is touched and a dent occurs, the first electrode layer 212 and the second electrode layer 222 may be conductive to each other. In this regard, a threshold thickness d0 can be defined as d1>d0≧d2. When the thickness of the extrinsic spacing layer 230 is less than the threshold thickness d0, the first electrode layer 212 and the second electrode layer 222 are conductive to each other; when the thickness of the extrinsic spacing layer 230 is greater than the threshold thickness d0, the first electrode layer 212 and the second electrode layer 222 are insulated from each other. A signal sensor (not shown) electrically connected to the first electrode layer 212 and the second electrode layer 222 of the touch panel 200 is in charge of judging the conductive status or the insulation status. The signal sensor is, for example, an IC dice for detecting the touch signal. The signal sensor can detect the voltage or the current passing the extrinsic spacing layer 230. When the thickness of the extrinsic spacing layer 230 is less than the threshold thickness d0, it is judged by the signal sensor as ‘conductive status’; when the thickness of the extrinsic spacing layer 230 is greater than the threshold thickness d0, it is judged by the signal sensor as ‘insulated status’. Since if only the thickness of the extrinsic spacing layer 230 is reduced, the first electrode layer 212 and the second electrode layer 222 can be conductive, the first electrode layer 212 and the second electrode layer 222 are not largely bent and thereby unlikely damaged.

For the usage convenience, the touch panel 200 can adhere to a display panel to function as a touch display panel. Therefore, the refractive index of the extrinsic spacing layer 230 is substantially greater than 1.3 but less than 2.0 for promoting the display quality of the touch display panel after the touch panel 200 adheres to the display panel. In addition, the material of the extrinsic spacing layer 230 can be transparent; therefore, the optical transmittance of the extrinsic spacing layer 230 is substantially greater than 85% but less than 100%. It is obviously the first electrode layer 212 and the second electrode layer 222 can use, for example, a transparent conductive material to increase the optical transmittance of the touch panel 200. The transparent conductive material is, for example, indium tin oxide (ITO), cadmium tin oxide (CTO), zinc aluminium oxide, indium zinc oxide (IZO), zinc oxide (ZnO), tin oxide (SnO₂) or one of the groups composed of the above-mentioned oxides.

In the embodiment, the extrinsic spacing layer 230 is formed by scattering the conductive particles 232 in the elastic silicone gel, so that the resistance coefficient of the extrinsic spacing layer 230 is changed to suit different applications. When the thickness of the extrinsic spacing layer 230 is changed, the resistance of the extrinsic spacing layer 230 is proportional to the thickness. In this way, when the extrinsic spacing layer 230 gets thinner, the first electrode layer 212 and the second electrode layer 222 are conductive to each other; i.e., the first electrode layer 212 and the second electrode layer 222 can be conductive without being largely bent or directly contacting, which benefits to lengthen the lifetime of the touch panel 200. Besides, the extrinsic spacing layer 230 is formed between the first electrode layer 212 and the second electrode layer 222, for example, in a vacuum environment. Thus, the gap between the first substrate 210 and the second substrate 220 is fully filled by the extrinsic spacing layer 230; and when light passes the touch panel 200, the light is unlikely scattered, which benefits to increase the optical transmittance of the touch panel 200.

In the embodiment, the first electrode layer 212 and the second electrode layer 222 are, for example, respectively formed on the whole first substrate 210 and the whole second substrate 220. But in other embodiments, the first electrode layer 212 and the second electrode layer 222 can respectively comprise a plurality of bar-shape electrodes or electrodes with other geometric shapes; it is to say the touch panel 200 can be used for analog calculation and digital calculation as well.

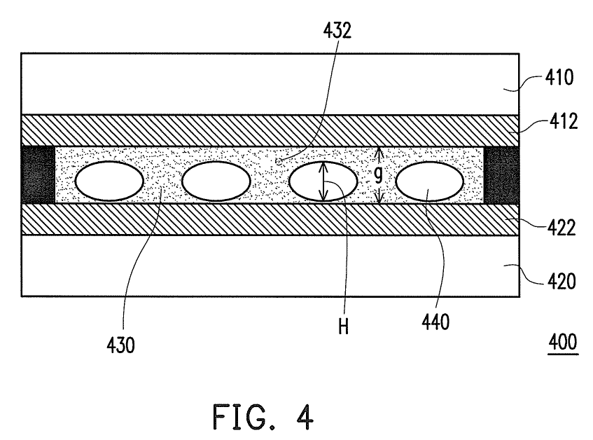

Moreover, the touch panel of the embodiment can use a liquid material as the extrinsic spacing layer. FIG. 4 is a cross-sectional diagram of a touch panel according to another embodiment of the present invention. Referring to FIG. 4, a touch panel 400 includes a first substrate 410, a first electrode layer 412, a second substrate 420, a second electrode layer 422, an extrinsic spacing layer 430 and a plurality of spacers 440. The first electrode layer 412 is disposed on the first substrate 410 and the second substrate 420 is parallel to the first substrate 410. The second electrode layer 422 is disposed on the second substrate 420, and the first electrode layer 412 and the second electrode layer 422 are located between the first substrate 410 and the second substrate 420. The extrinsic spacing layer 430 is located between the first electrode layer 412 and the second electrode layer 422, and a plurality of conductive particles 432 is scattered in the extrinsic spacing layer 430.

In more detail, the touch panel 400 of the embodiment uses a different material as the extrinsic spacing layer 430 from the touch panel 200 of the above-mentioned embodiment, but the other parts use the same materials as the above-mentioned embodiment. In the embodiment, the material of the extrinsic spacing layer 430 is a liquid material and the extrinsic spacing layer 430 further has a plurality of spacers 440, wherein the height H of the spacers 440 is less than the gap g between the first substrate 410 and the second substrate 420. In fact, the above-mentioned liquid material is, for example, liquid crystal, and the conductive particles 432 are evenly scattered in the liquid crystal to form the extrinsic spacing layer 430 of the embodiment.

Note that the liquid material has good fluidity but lacks spring-back potency; therefore, the embodiment further employs the spacers 440 disposed in the touch panel 400. When the user presses the touch panel 400 and then the pressure is relieved, the first substrate 410 is restored to its original shape due to its own elasticity and the effect of the spacers 440. In other words, even the extrinsic spacing layer 430 is made of a liquid material, the touch panel 400 still is able to quickly restore its original shape to facilitate the touch control operations. The liquid material in the embodiment is allowed to have a refractive index roughly equal to that of the first substrate 410 and the second substrate 420, so that the optical performance of the touch panel 400 is promoted.

In summary, the present invention adopts a extrinsic spacing layer having elasticity and fluidity as the interlayer between the first electrode layer and the second electrode layer in the touch panel, and the resistance of the extrinsic spacing layer is varied with the thickness thereof; therefore, the first electrode layer and the second electrode layer can be conductive to each other without being largely bent or contacting each other, which benefits to lengthen the lifetime of the first electrode layer and the second electrode layer. In addition, the extrinsic spacing layer has good optical transmittance to largely promote the optical characteristic of the touch panel. If the touch panel of the present invention adheres to a display panel, it is helpful to maintain the good display quality of the display panel. In short, the touch panel of the present invention is advantageous in longer lifetime and better quality.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A touch panel, comprising:
a first substrate;
a first electrode layer, disposed on the first substrate;
a second substrate, positioned parallel to the first substrate;
a second electrode layer, disposed on the second substrate, wherein the first electrode layer and the second electrode layer are located between the first substrate and the second substrate; and
an extrinsic spacing layer, located between the first electrode layer and the second electrode layer, wherein a plurality of conductive particles are scattered in the extrinsic spacing layer.

2. The touch panel according to claim 1, wherein a material of the extrinsic spacing layer is an elastic material.

3. The touch panel according to claim 2, wherein the elastic material comprises silicone gel or acrylic gel.

4. The touch panel according to claim 1, wherein a material of the extrinsic spacing layer is a liquid material having a plurality of spacers, wherein heights of the spacers are less than a gap between the first substrate and the second substrate.

5. The touch panel according to claim 4, wherein the liquid material is a liquid crystal.

6. The touch panel according to claim 1, wherein the conductive particles are a plurality of nanoparticles.

7. The touch panel according to claim 6, wherein the nanoparticle comprises silver nanoparticles, carbon nanoparticles, carbon nanotubes, silver nanospiders, zinc oxide (ZnO) nanoparticles, indium tin oxide (ITO) nanoparticles, titanium nanoparticles or a combination thereof.

8. The touch panel according to claim 1, wherein a material of the conductive particles is a conductive polymer.

9. The touch panel according to claim 8, wherein the conductive polymer comprises polyethylene dioxythiophene (PEDOT) or polyaniline (PANI).

10. The touch panel according to claim 1, wherein a resistance of the extrinsic spacing layer is proportional to a thickness of the extrinsic spacing layer.

11. The touch panel according to claim 1, wherein a refractive index of the extrinsic spacing layer is substantially greater than 1.3 but less than 2.0.

12. The touch panel according to claim 1, wherein the optical transmittance of the extrinsic spacing layer is substantially greater than 85% but less than 100%.

13. The touch panel according to claim 1, wherein a material of the first substrate and the second substrate comprises glass, acrylate, polyamide, polyethylene terephthalate (PET), polycarbonate (PC) or a combination thereof.

14. The touch panel according to claim 1, wherein a material of the first electrode layer and the second electrode layer comprises indium tin oxide (ITO), cadmium tin oxide (CTO), zinc aluminium oxide, indium zinc oxide (IZO), zinc oxide (ZnO), tin oxide (SnO₂) or a combination thereof.

15. A touch panel, comprising:
a first substrate;
a first electrode layer, disposed on the first substrate;
a second substrate, positioned parallel to the first substrate;
a second electrode layer, disposed on the second substrate, wherein the first electrode layer and the second electrode layer are located between the first substrate and the second substrate; and
an extrinsic spacing layer, located between the first electrode layer and the second electrode layer and having a thickness, wherein the extrinsic spacing layer comprises an insulation elastic material and a plurality of conductive particles scattered in the insulation elastic material, so that a resistance of the extrinsic spacing layer is proportional to the thickness of the extrinsic spacing layer.

16. The touch panel according to claim 15, further comprising a signal sensor electrically connected to the first electrode layer and the second electrode layer, wherein when the thickness is less than a threshold thickness, the resistance of the extrinsic spacing layer is reduced; when the thickness is greater than the threshold thickness, the resistance of the extrinsic spacing layer is increased; and two statuses are used to decide whether or not the signal sensor is able to detect a voltage or a current passing the extrinsic spacing layer.

17. The touch panel according to claim 15, wherein the insulation elastic material comprises silicone gel or acrylic gel.

18. The touch panel according to claim 15, wherein the a refractive index of the extrinsic spacing layer is substantially greater than 1.3 but less than 2.0, and an optical transmittance of the extrinsic spacing layer is substantially greater than 85% but less than 100%.
